(19) United States
(12) Patent Application Publication
(10) Pub. No.: US 2019/0253017 A1
(43) Pub. Date: Aug. 15, 2019

(54) Integrated Motor Operation Data Collection and Operation Protection Device

(71) Applicant: Lurong Ye, Richardson, TX (US)

(72) Inventor: Lurong Ye, Richardson, TX (US)

(73) Assignee: Lurong Ye, Richardson, TX (US)

(21) Appl. No.: 16/266,076

(22) Filed: Feb. 3, 2019

Related U.S. Application Data
(60) Provisional application No. 62/629,039, filed on Feb. 11, 2018.

(51) Int. Cl. H02P 29/024; H02P 29/50; H02P 29/66; H02P 29/032

(52) U.S. Cl. CPC H02P 29/024; H02P 29/032; H02P 29/664; H02P 29/50

(57) ABSTRACT

This invention discloses an Integrated Motor Operation Data Collection and Operation Protection Device. The device is integrated inside of a motor. Its temperature sensors are distributed on windings, slots, lamination, and bearings. The voltage sensing is through the terminal binding posts. The current sensors are clamped on the connections between the terminal binding pasts and windings. The vibration sensor and the on board temperature sensor are integrated on the monitor board. The MCU runs the firmware which performs data collection, data analysis, communication, alarm report and data storage.

### TECHNICAL FIELD

This disclosure is related to a device application to the motor real time operation, data collection, data output, and motor operation condition analysis and protection. The so called motor is referred to all type motors, which include motors and generators.

### TECHNICAL BACKGROUND

Motors have been used in every aspects of our life as a driving force or a control device. In a typical machine or a system, traditional motor is usually used as an independent operation device. Its operation data, status, parameters are not monitored due to the technical restriction and the cost concern. The consequence is: Motor's operation condition is not monitored and the motor may be operated in a no-safe or a low efficiency condition all the time, or its pre-failure condition is not warned, or its working environment is not met with the specification. So the motor's life time and working efficiency are affected. The result is the motor's breakdown without any pre-warning. Maintenance personnel will not involve until the motor failure, causing a long breakdown time. Furthermore, the operation condition just before the motor failure is not recorded and there is no useful data to help the failure analysis and further protection.

### The Invention:

For the purpose of the useful data collection and the motor protection, this invention provides a solution of the integrated motor real time operation data collection and motor operation protection. That is: the data collection and motor protection functions are implemented inside of the motor. The data and the related operation alarms will be saved in the motor. And several data interfaces are implemented for the communication to the up-level system.

The technical solution of this invention to the technical problem is an Integrated Motor Operation Data Collection and Operation Protection Device as following.

The Integrated Motor Operation Data Collection and Operation Protection Device consists of the Monitor Board, all sensors and wirings. All these parts are integrated inside of the motor.

The data collection is implemented in following methods. Motor internal temperatures are measured by the Temperature Sensors pre-buried in the motor. The motor voltages are measured on the motor terminals in the Terminal Box. The motor currents are measured through the wires connected from the motor terminal to the windings. The Vibration Sensor on the Monitor Board will sense the vibration of the motor. All these sensors will be connected to the Monitor Board. All these data will be real time monitored during the operation. The micro-controller, MCU, on the Monitor Board will analyze the operation condition, issue alarms and protect the motor when it is necessary.

The Temperature Sensors are distributed inside of the motor in the Stator lamination, Slot winding in the slots, End Winding, Front Bearing and Real Bearing, motor interior and the Terminal Box. External temperature is measured by the external sensor connected to the Monitor Board.

The voltages are measured through the motor Terminal Binding Posts. Currents measurement is performed through the wires connected the terminals to the windings. The voltage and current measurements apply to all phases.

Motor vibration is monitored through the Vibration Sensor mounted on the Monitor Board.

The Monitor Board is integrated in the motor Terminal Box. All internal sensors inside the motor are connected to the Monitor Board and they are pre-wired in the production line. The appearance of the motor with the Integrated Motor Operation Data Collection and Operation Protection Device looks the same as the regular motor. The installation dimension and motor mounting fixture keep same. For the pre-existing motors in the field, this device can be field installed into the motor to perform the same function.

Because this device and all sensors, such as temperature, voltage, current, vibration, are integrated inside the motor, and pre-wired and tested in the production line, so, this is an embedded invention. No extra wiring is needed for customer in the field.

### The Effectiveness of the Invention:

Through the sensors buried in the motor and the pre-installed Monitor Board during the production line, the internal operation condition monitoring is more accurate in real time than the traditional external monitoring mechanism. The monitoring and the protection functions will not be affected by the failure of the external monitor instrument, communication connection and network. The reliability of the monitoring and the protection is increased. In field applications, due to the device's plug and play feature, no extra field installation and wiring are needed, which leads to the lower field installation cost.

By monitoring the motor temperature, voltage, current, vibration in real time, the motor operation condition can be accurately monitored and saved in the EEPROM of the MCU (Micro Controller Unit). In the case of an abnormal operation condition, this integrated device will send out warning or alarm signals.

These warnings and alarms will trig the external control equipment to adjust the motor's operation mode, such as reducing the load and/or the speed or even to shutdown the motor. The saved data will be used for the post-event alarm analysis and be utilized to the future operation improvement.

By these mentioned above temperature, voltage, current, vibration data, through the MCU's data analysis firmware, further data can be generated:

1. Monitor the motor internal temperature;
2. Monitor the phase voltage operation range;
3. Monitor the phase current operation range;
4. Present power;
5. Present power factor;
6. Monitor the phase voltage sequence (motor rotation direction);
7. Monitor the imbalance of the phase voltages;
8. Monitor the imbalance of the phase currents;
9. Monitor the phase voltage distortion;
10. Monitor the phase current distortion;
11. Monitor the motor's vibration;
12. Record the total accumulated operation time;
13. Record the last power-up time and duration;
14. Create the maintenance schedule based on the accumulated operation time;
15. Record the accumulated KWH, derive the carbon emission volume;
16. Record the warnings and alarms history in the device with time stamp.
17. Alarms for the above conditions, such as over voltage, under voltage, voltage imbalance, over current, current imbalance, over temperature, power factor abnormal, over load, vibration exceed, etc. Meantime, send out the alarms through the interface.

### BRIEF DESCRIPTION OF THE FIGURES

Following disclosure is an embodiment of the device implementation with the attached figures.

FIG. 1 shows the motor with the Integrated Motor Operation Data Collection and Operation Protection Device and its sensors distribution inside of the motor.

FIG. 2 shows the detailed motor Terminal Box shown in FIG. 1.

FIG. 3 shows the block diagram of the Monitor Board.

Where:

Motor Body 1; Stator 2; Temperature Sensors 3; Rotor 4; End Winding 5; Terminal Box 6; Monitor Board 7; Front Bearing 8; Rear Bearing 9; Base 10; Rear End Cover 11; Front End Cover 12; Slot Winding 13; External Power Wires 14; Voltage Sensor Wire 15 (diamond symbol); Current Sensors 16; Three Phase Wires 17; Connection Wires 18; Voltage Input 19; Current Sensor Input 20; Internal Temperature Sensor Input 21; External Temperature Sensor Input 22; On Board Power Supply 23; Display 24; Relay Output 25; Serial Port 26; Wireless COM Port 27; MCU 28; Vibration Sensor 29; On Board Temperature Sensor 30; Terminal Binding Posts 31.

### DETAILED DESCRIPTION OF THE EMBODIMENT

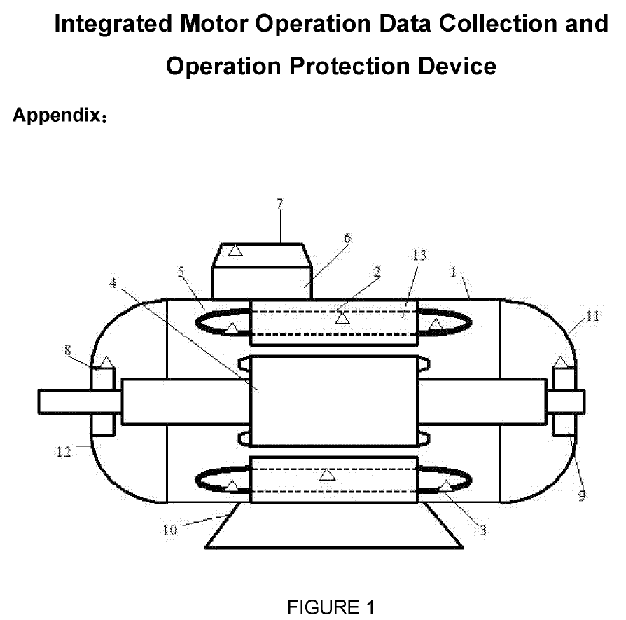

In FIG. 1: The Motor Body 1 consists of Stator 2, Rotor 4, Front End Cover 12 and Rear End Cover 11. At Front End Cover 12 there is the Front Bearing 8 and at Rear End Cover 11 there is the Rear Bearing 9. The stator winding consists of two parts: the Slot Winding 13 and the End Winding 5. The multiple temperature sensors are distributed inside of the motor. The Temperature Sensors 3 are marked with delta symbol (Δ). The Terminal Box 6 is at the same location as the regular motors′. The integrated motor operation data collection and operation protection board, Monitor Board 7, is in the Terminal Box 6. The motor is supported by its Base 10.

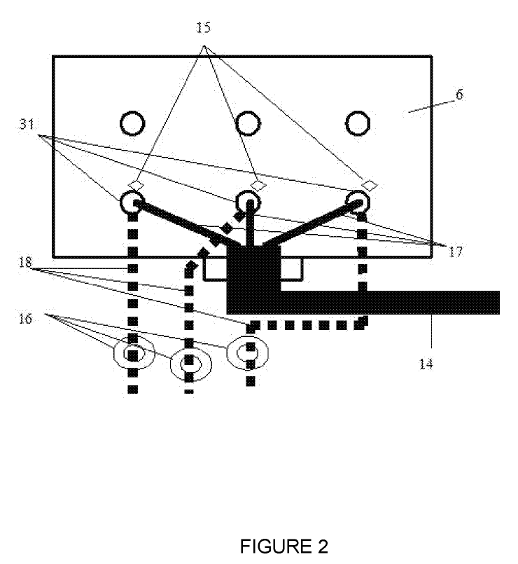

In FIG. 2: It is the detailed wiring of the Terminal Box 6 from FIG. 1. There are the Terminal Binding Posts 31, the External Power Wires 14 and the Three Phase Wires 17 which are connected to the Terminal Binding Posts 31. The Voltage Sensor Wire 15 (diamond symbol) is connected to the Terminal Binding Posts 31. The Current Sensors 16 are clamped around the Connection Wires 18 which are between the motor winding and the Terminal Binding Posts 31.

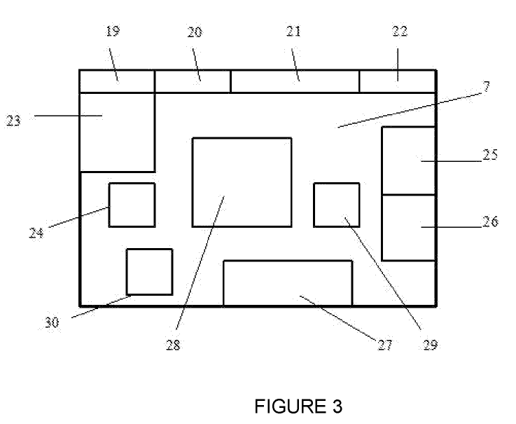

In FIG. 3: the Monitor Board has inputs and outputs, Display 24, Vibration Sensor 29, On Board Temperature Sensor 30, On Board Power Supply 23 and MCU 28. The inputs are Voltage Input 19, Current Sensor Input 20, Internal Temperature Sensor Input 21 and External Temperature Sensor Input 22. The outputs have Relay Output 25, Serial Port 26 and Wireless Com Port 27.

The Internal Temperature Sensors 3 (multiple Δ symbols) in FIG. 1 are pre-installed inside the motor on the production line. Their positions are shown in the FIG. 1. The Voltage Sensor Wiring 15 (diamond symbol) is finished in the assembly line and this wiring is independent to the External Power Wire 14 and the Three Phase Wire 17 connection as shown in FIG. 2. The Current Sensors 16 in FIG. 2 are also installed and wired in the production line with the Terminal Binding Posts 31 installation. The Monitor Board 7 is installed in the Terminal Box 6 in the production line, including all its wirings. The Monitor Board 7's function test is conducted with the regular motor production line qualification test. Therefore, to a traditional customer, the existence of the Monitor Board 7 is transparent in terms of field motor installation, wiring, provision and operation.

When the motor with the device is powered up through external breaker and Power Wire 14, the motor starts to rotate. Meanwhile, Monitor Board 7 is powered up, too, by the On Board Power Supply 23. And it starts to function. The motor temperatures change and they are monitored by the Temperature Sensors 3. The Voltage Sensors 15 monitor the voltage change and the Current Sensors 16 monitor the current change along the load and voltage change. The Vibration Sensor 29 monitors the motor vibration. The MCU 28 detects the sensors and does all the calculations. The Relay Output 25, the Serial Port 26 and Wireless COM Port 27 send out the operation data and alarms if they occur.

Because all sensors are internal, the data collected truly reflect the motor internal condition in real time. The derived functionalities, performed by the MCU firmware, are described in [0012].

While this disclosure has described certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure, as defined by the following claims.

What is claimed:

1. An Integrated Motor Operation Data Collection and Operation Protection Device, including the device's enclosure, all sensors and the Monitor Board, where the MCU is the core of the device on a Monitor Board which further comprising the Voltage Input, Current Input, Internal Temperature Sensor Input, External Temperature Sensor Input, On Board Power Supply, Display, Relay Output, Serial Port, Wireless COM Port, Vibration Sensor and the On Board Temperature Sensor.

2. The Integrated Motor Operation Data Collection and Operation Protection Device of claim 1, further comprising the distributed Voltage Sensor Wire, the Current Sensors and the Temperature Sensors to complete the functionality.

3. The Monitor Board of the claim 1, where it is installed inside of the Terminal Box or just externally mounted outside of the motor.

4. The Temperature Sensors of the claim 2, where they are installed on the Slot Winding, the End Winding, the Front Bearing and the Rear Bearing; they are pre-buried in the motor in the production line and finally connected to the Internal Temperature Sensor Input.

5. The distributed Voltage Sensor Wire of the claim 2, where it is connected from the Terminal Binding Posts to the Voltage Input on the Monitor Board and finished in the production line.

6. The distributed current Sensor of claim 2, where it is clamped on the Connection Wire and its output is connected to the Current Sensor Input as the last step of the assembly.

7. The Vibration Sensor of the claim 1, where it is integrated on the Monitor Board.

8. The Internal Temperature Sensor of the claim 1, where it is integrated on the Monitor Board.

9. The Relay Output of the claim 1, where it is integrated on the Monitor Board.

10. The Serial Port and the Wireless COM Port of the claim 1, where they are integrated on the Monitor Board.

11. The MCU of the claim 1, where the operation data, alarms and the protection data are stored and the control program firmware
